(19) United States
(12) Patent Application Publication
(10) Pub. No.: US 2014/0335378 A1
(43) Pub. Date: Nov. 13, 2014

(54) ELECTRIC STORAGE DEVICE, SUBSTRATE ASSEMBLY, AND ASSEMBLY METHOD FOR ELECTRIC STORAGE DEVICE

(71) Applicant: Toyota Jidosha Kabushiki Kaisha, Toyota-shi Aichi-ken (JP)

(72) Inventor: Kazushi Kuroda, Miyoshi-shi Aichi-ken (JP)

(73) Assignee: TOYOTA JIDOSHA KABUSHIKI KAISHA, Toyota-shi Aichi-ken (JP)

(21) Appl. No.: 14/271,952

(22) Filed: May 7, 2014

(30) Foreign Application Priority Data
May 9, 2013 (JP) 2013-099613

(51) Int. Cl. H01M 2/20

(52) U.S. Cl. CPC H01M 2/206
USPC 429/7; 29/623.1

(57) ABSTRACT

An electric storage device includes a plurality of electric storage elements, a substrate, and a bus bar. The plurality of electric storage elements are arranged in a predetermined direction. An electrode terminal of each of the electric storage elements penetrates through the substrate. The bus bar is coupled to the electrode terminal penetrating through the substrate. The bus bar electrically couples the plurality of electric storage elements to each other. A voltage detecting line and an electronic circuit are mounted to the substrate. The voltage detecting line is electrically coupled to the electrode terminal. The voltage detecting line is configured to detect a voltage of each of the electric storage elements. The electronic circuit is coupled to the voltage detecting line.

### INCORPORATION BY REFERENCE

The disclosure of Japanese Patent Application No. 2013-099613 filed on May 9, 2013 including the specification, drawings and abstract is incorporated herein by reference in its entirety.

### BACKGROUND OF THE INVENTION

1. Field of the Invention

The present invention relates to an electric storage device where a substrate including wiring is mounted to a plurality of electric storage elements, a substrate assembly, and an assembly method for electric storage device.

2. Description of Related Art

In a battery pack constituted with a plurality of cells, a plurality of cells are electrically coupled to each other with bus bars. A voltage value of each cell in the battery pack may be detected. A voltage detecting line is coupled to each cell. International Publication Number WO 2010/113455 and Japanese Patent Application Publication No. 2012-074338 (JP 2012-074338 A) disclose the following. A plurality of voltage detecting lines are disposed at a substrate. The voltage detecting lines are to be coupled to an electronic circuit via connectors.

In International Publication Number WO 2010/113455 and JP 2012-074338 A, the voltage detecting lines are simply disposed at the substrate. The electronic circuit coupled to the voltage detecting line is disposed separately from the substrate. This configuration requires work to couple the voltage detecting line to the electronic circuit.

### SUMMARY OF THE INVENTION

An electric storage device of a first aspect of the present invention includes a plurality of electric storage elements, a substrate, and a bus bar. The plurality of electric storage elements are arranged in a predetermined direction. An electrode terminal of each of the electric storage elements penetrates through the substrate. The bus bar is coupled to the electrode terminal penetrating through the substrate. The bus bar electrically couples the plurality of electric storage elements to each other. A voltage detecting line and an electronic circuit are mounted to the substrate. The voltage detecting line is electrically coupled to the electrode terminal. The voltage detecting line is configured to detect a voltage of each of the electric storage elements. The electronic circuit is coupled to the voltage detecting line.

According to the first aspect of the present invention, not only the voltage detecting line but also the electronic circuit to which the voltage detecting line is coupled is also mounted to the substrate. In view of this, a circuit configuration for detecting a voltage of the electric storage element can be assembled to the substrate. Accordingly, it is only necessary that the substrate is mounted to the plurality of electric storage elements. This eliminates the need for work for coupling the voltage detecting line to the electronic circuit.

The electric storage element may include a valve configured to emit gas generated inside the electric storage element to an outside of the electric storage element. The substrate may include an opening configured to cause gas emitted from the valve to pass through the opening and guide to a duct. This configuration can reduce contact of gas emitted from the valve to the substrate. Furthermore, in a case where the substrate is disposed between the duct and the electric storage elements, for example, an opening is formed at the substrate. Forming an opening at the substrate allows gas emitted from the valve to pass through the opening of the substrate and be guided to the duct.

A sealing member may be disposed between the substrate and the valve. Here, the sealing member may be disposed at a position surrounding the valve and the opening. By using the sealing member, it is possible to prevent leakage of gas from between the substrate and the valve (the electric storage element) even if gas is emitted from the valve. Gas emitted from the valve can be efficiently guided to the duct via the opening of the substrate.

The nut may be tightened to the electrode terminal penetrating through the substrate. Here, when the electrode terminal penetrates the substrate and the bus bar, by tightening the nut to the electrode terminal, it is possible to secure the substrate and the bus bar in a longitudinal direction of the electrode terminal. Furthermore, in a case where the bus bar is disposed between the nut and the substrate, for example, it is possible to secure the bus bar to the electrode terminal or press the bus bar against the substrate by tightening the nut to the electrode terminal. By pressing the bus bar against the substrate, it is possible to bring the voltage detecting line, which is mounted to the substrate, and the bus bar closely in contact with each other. This makes it possible to ensure a conductive state of the voltage detecting line and the bus bar.

The bus bar may be disposed between the nut and the substrate. With a configuration where the nut is directly brought into contact with the substrate, the substrate may be deformed during tightening the nut. As described above, when the bus bar is disposed between the nut and the substrate, force of tightening the nut simply acts on the bus bar. Thus, deformation of the substrate in association with tightening the nut is reduced.

With the configuration of tightening the nut to the electrode terminal, a spring washer through which the electrode terminal penetrates may be disposed. Here, the spring washer biases the members that sandwich the spring washer to the direction of separating from one another in the longitudinal direction of the electrode terminal. Thus, the members sandwiching the spring washer can be positioned in the longitudinal direction of the electrode terminal. The members sandwiching the spring washer are, for example, an electric storage element, the substrate, the bus bar, and the nut.

The electric storage device may include a temperature sensor configured to detect a temperature of the electric storage element. Here, the temperature sensor may be mounted to the substrate, and may be coupled to the temperature sensor and the electronic circuit. This allows the electronic circuit to obtain information detected by the temperature sensor.

A reinforcing member may be stacked on the substrate. Stacking the substrate and the reinforcing member can reduce deformation of the substrate. As described above, the voltage detecting line and the electronic circuit are mounted to the substrate. Therefore, if the substrate is deformed, poor coupling of the voltage detecting line and the electronic circuit or a similar failure may occur. Therefore, use of the reinforcing member can reduce deformation (deflection) of the substrate. Accordingly, poor coupling of the voltage detecting line and the electronic circuit or a similar failure can be prevented.

Here, the reinforcing member may be disposed over the entire substrate or may be disposed at a part of the substrate. Use of the plurality of reinforcing members can arrange the reinforcing members at a plurality of portions at the substrate. The substrate may be a flexible substrate. In the case where the flexible substrate is employed as the substrate, the substrate is likely to deform. Accordingly, use of the reinforcing member facilitates reducing deformation of the flexible substrate.

The substrate may be formed with a heat-resistant material. Here, with the configuration where the substrate is arranged at the position where the substrate faces the valve of the electric storage element, the substrate may be thermally deformed by high temperature gas emitted from the valve. Therefore, forming the substrate with the heat-resistant material can reduce thermal deformation of the substrate even if gas contacts the substrate. As the heat-resistant material, for example, a glass epoxy resin may be employed.

A second aspect of the present invention is a substrate assembly mounted to a plurality of electric storage elements arranged in a predetermined direction. The substrate assembly includes an opening and a mounting region. An electrode terminal of each of the electric storage elements penetrates through the opening. The mounting region is coupled to the electrode terminal penetrating through the opening. A bus bar is mounted to the mounting region. The bus bar electrically couples the plurality of electric storage elements to each other. The substrate assembly further includes a voltage detecting line and an electronic circuit. The voltage detecting line is mounted to the substrate. The voltage detecting line is electrically coupled to the electrode terminal. The voltage detecting line is configured to detect a voltage of each of the electric storage elements. The electronic circuit is mounted to the substrate. The voltage detecting line is coupled to the electronic circuit. With the second aspect of the present invention, the effects similar to those in the first aspect of the present invention can be obtained.

A third aspect of the present invention is an assembly method for an electric storage device with a plurality of electric storage elements electrically coupled in series to a bus bar. The assembly method includes: arranging the plurality of electric storage elements in a predetermined direction; and coupling an electrode terminal of each of the electric storage elements to a voltage detecting line in an order from one of the electric storage elements positioned at an end of the electric storage device in the predetermined direction. The coupling is performed while causing the electrode terminal of each of the electric storage elements to penetrate through a substrate where the voltage detecting line and an electronic circuit are mounted. The voltage detecting line is configured to detect a voltage of each of the electric storage elements. The electronic circuit is coupled to the voltage detecting line.

With the third aspect of the present invention, the effects similar to those in the first aspect of the present invention can be obtained.

The plurality of electric storage elements are electrically coupled in series to each other. Accordingly, if the electrode terminals and the voltage detecting lines are irregularly coupled to each other, overcurrent may flow due to the parasitic diode of the electronic circuit (for example, the monitor IC) coupled to the electric storage elements (the electrode terminals) via the voltage detecting line. For example, irregular coupling of the electrode terminals and the voltage detecting line may cause terminals of the plurality of electric storage elements to couple to the electronic circuit with the plurality of electric storage elements electrically coupled in series.

According to the third aspect of the present invention, the electrode terminals and the voltage detecting line are coupled to each other in the order from the electric storage element positioned at the end of the electric storage device in the predetermined direction. In view of this, as described above, this can prevent the terminals of the plurality of electric storage elements from being coupled to the electronic circuit with the plurality of electric storage elements electrically coupled in series to each other. Accordingly, the overcurrent due to the parasitic diode of the electronic circuit (for example, the monitor IC that detects a voltage of the electric storage element) mounted to the substrate can be prevented or reduced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an exploded view of a cell stack of an embodiment of the present invention;

FIG. 2 is an external view of a cell of the embodiment of the present invention;

FIG. 3 is a top view of a substrate of the embodiment of the present invention;

FIG. 4 is a bottom view of a duct of the embodiment of the present invention;

FIG. 5 is a cross-sectional view illustrating a structure for emitting gas from the cell of the embodiment of the present invention;

FIG. 6 is a circuit diagram illustrating a circuit configuration disposed at the substrate of the embodiment of the present invention;

FIG. 7 is a schematic view illustrating a structure that detects a temperature of the cell using a thermistor of the embodiment of the present invention;

FIG. 8 is an explanatory view of when the substrate is mounted to a plurality of cells of the embodiment of the present invention;

FIG. 9 is a view illustrating a structure for reinforcing the substrate of the embodiment of the present invention;

FIG. 10 is a view illustrating a structure for reinforcing the substrate of the embodiment of the present invention; and

FIG. 11 is an exploded view of a cell stack of a modification of the embodiment.

### DETAILED DESCRIPTION OF EMBODIMENTS

Embodiments of the present invention will hereinafter be described.

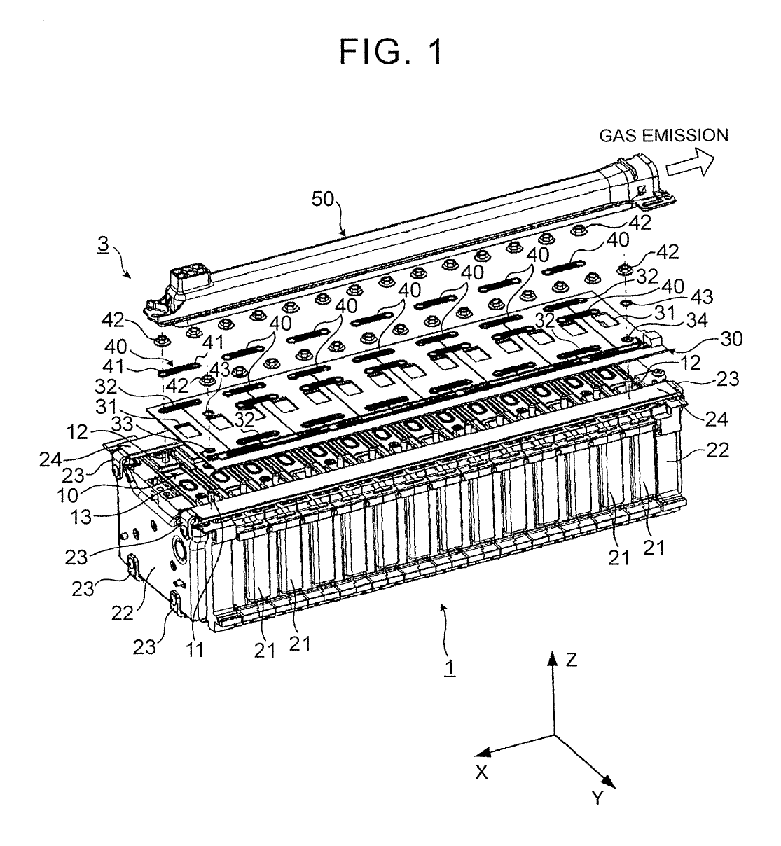

A cell stack 1 of the embodiment of the present invention will be described by referring to FIG. 1. The cell stack 1 may be regarded as an electric storage device of the present invention. FIG. 1 is an exploded view of a cell stack. In FIG. 1, an X-axis, a Y-axis, and a Z-axis represent axes orthogonal to each other. In this embodiment, an axis corresponding to the vertical direction represents the Z-axis. The relationship among the X-axis, the Y-axis, and the Z-axis applies to other figures.

The cell stack 1 illustrated in FIG. 1 can be mounted on a vehicle. The cell stack 1 can be used as a power source for running a vehicle. Electric energy output from the cell stack 1 is converted by a motor generator into kinetic energy which can be used for running the vehicle. Kinetic energy generated in braking of the vehicle is converted by the motor generator into electric energy which can be stored in the cell stack 1 as regenerative electric power.

The cell stack 1 includes a plurality of cells 10 that are aligned in the X direction. The cell 10 may be regarded as an electric storage element of the present invention. As the cell 10, a secondary battery such as a nickel metal hydride battery and a lithium ion battery may be employed. Instead of the secondary battery, an electric double-layer capacitor (a capacitor) may be employed. Here, the plurality of cells 10 are electrically coupled in series to each other. The number of the cells 10 constituting the cell stack 1 may be set appropriately based on an output required for the cell stack 1 or a similar condition.

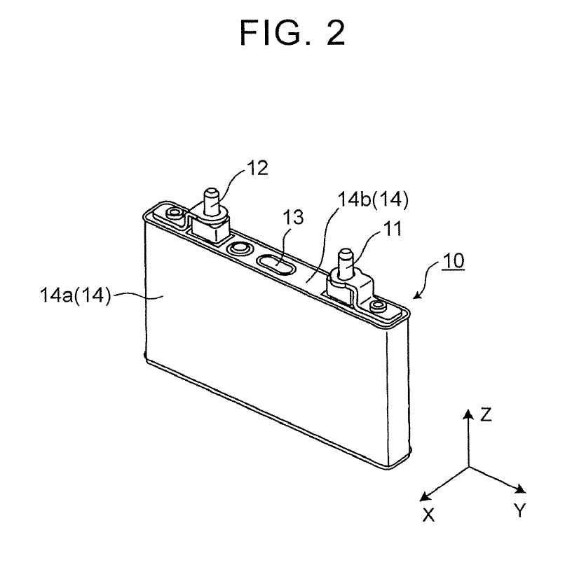

Here, the configuration of the cell 10 will be described using FIG. 2.

FIG. 2 is an external view of the cell 10.

The cell 10 includes a battery case 14. The battery case 14 includes a case body 14a and a lid 14b. The battery case 14 houses a power generating element (not illustrated) that performs charge and discharge in an inside thereof. The case body 14a includes an opening to incorporate the power generating element. The lid 14b covers the opening of the case body 14a. The inside of the battery case 14 is sealed. The cell 10 is a so-called square-shaped cell. The battery case 14 is formed to have a shape along the rectangular parallelepiped.

The power generating element includes a positive electrode plate, a negative electrode plate, and a separator disposed between the positive electrode plate and the negative electrode plate. The positive electrode plate is constituted by a current collector plate and a cathode active material layer formed on a surface of the current collector plate. The negative electrode plate is constituted by the current collector plate and an anode active material layer formed on a surface of the current collector plate. Here, electrolytic solution is impregnated into the cathode active material layer, the anode active material layer, and the separator. Instead of the electrolytic solution, solid electrolyte may be employed. In this case, it is only necessary to dispose the solid electrolyte between the positive electrode plate and the negative electrode plate, and a separator is omitted.

The lid 14b is provided with a positive electrode terminal (also referred to as an electrode terminal) 11 and a negative electrode terminal (also referred to as an electrode terminal) 12. The positive electrode terminal 11 is electrically coupled to the positive electrode plate (the current collector plate) of the power generating element. The negative electrode terminal 12 is electrically coupled to the negative electrode plate (the current collector plate) of the power generating element. The lid 14b includes a valve 13. Specifically, the valve 13 is disposed between the positive electrode terminal 11 and the negative electrode terminal 12 in the Y direction. The valve 13 is constituted such that gas generated at the inside of the battery case 14 is emitted to the outside of the battery case 14.

For example, if the cell 10 (the power generating element) is excessively charged, gas may be generated from the power generating element (mainly, an electrolytic solution). Since the battery case 14 is sealed, in association with generation of gas, the internal pressure in the battery case 14 increases. When the internal pressure in the battery case 14 reaches working pressure of the valve 13, the valve 13 changes from a close state to an open state. Accordingly, gas can be emitted to the outside of the battery case 14.

As the valve 13, a so-called break-type valve and a so-called recovery-type valve may be employed. With the break-type valve 13, the valve 13 irreversibly changes from the close state to the open state. For example, carving the lid 14b may form the break-type valve 13. On the other hand, with the recovery-type valve 13, the valve 13 reversibly changes between the close state and the open state corresponding to the internal pressure of the battery case 14. For example, use of the spring may constitute the recovery-type valve 13.

This embodiment arranges the plurality of cells 10 in the X direction. However, this should not be construed in a limiting sense. Specifically, a cell module may be used instead of the cell 10, and a plurality of cell modules may be arranged in the X direction. The cell module includes a module case and a plurality of power generating elements. The module case constitutes the exterior of the cell module. The plurality of power generating elements are housed in the module case. Here, the plurality of power generating elements are electrically coupled in series to each other at the inside of the module case.

In the cell stack 1 illustrated in FIG. 1, a partition plate 21 is disposed between the two cells 10 adjacent to one another in the X direction. The partition plate 21, for example, can be formed with an insulating material such as a resin. The two cells 10 sandwiching the partition plate 21 can be insulated. At a side surface of the partition plate 21 facing the cell 10 in the X direction, a rib (not illustrated) projecting in the X direction is formed. Bringing the distal end of the rib in contact with the cell 10 forms a space between the cell 10 and the partition plate 21. This space becomes a space where a heat exchange medium transfers. The heat exchange medium is employed for adjusting temperature of the cell 10.

As the heat exchange medium, gas (such as air) or liquid may be used. In this embodiment, the heat exchange medium flows in the Y direction. When the cell 10 generates heat by charge and discharge or similar, the heat exchange medium for cooling is brought into contact with the cell 10 using the above-described space. Thus, temperature rise of the cell 10 can be reduced. If the cell 10 is excessively cooled due to outer environment or a similar cause, the heat exchange medium for warming is brought into contact with the cell 10 using the above-described space. Thus, temperature fall of the cell 10 can be reduced.

At both ends of the cell stack 1 in the X direction, a pair of end plates 22 are disposed. To the pair of end plates 22, both end portions of restraint bands 23 extending in the X direction are secured. For example, by using a tightening tool such as a rivet, the end portion of the restraint band 23 may be secured to the end plate 22. In this embodiment, the two restraint bands 23 are disposed at the top surface of the cell stack 1 while the two restraint bands 23 are disposed at the bottom surface of the cell stack 1. The number of restraint bands 23 may be set appropriately.

Securing the restraint band 23 to the pair of end plates 22 can provide the cell 10 with restraint with the end plate 22. The restraint means a force sandwiching the cell 10 in the X direction. Securing the restraint bands 23 to the pair of end plates 22 can deflect the pair of end plates 22 in the direction where the pair of end plates 22 approach one another (the X direction). In association with this, the restraint can be provided to the plurality of cells 10 sandwiched between the pair of end plates 22.

In this embodiment, the restraint bands 23 (excluding both end portions) are covered with a cover 24. The restraint band 23 can be formed with a metal. In this case, the cover 24 may be formed with an insulating material such as a resin. As illustrated in FIG. 1, the restraint band 23 is positioned adjacent to electrode terminals 11 and 12 in the Y direction. Specifically, the restraint band 23 is disposed at the opposite side from the valve 13 side with respect to the electrode terminals 11 and 12.

In view of this, the metallic restraint band 23 is covered with the cover 24 formed with insulating material, thus the restraint band 23 and the electrode terminals 11 and 12 can be insulated. The cover 24 may be omitted insofar as the restraint band 23 is positioned away of the electrode terminals 11 and 12.

At the top surface of the cell stack 1, a substrate 30 is disposed. The substrate 30 is disposed at a position covering the top surface of the cell stack 1. The substrate 30, for example, can be formed with a heat-resistant material. As the heat-resistant material, for example, a glass epoxy resin may be employed.

The substrate 30 may include openings 31. The openings 31 are disposed by the number of the cells 10. Here, the plurality of openings 31 are aligned in the X direction. Each opening 31 faces the valve 13 of each cell 10 in the Z direction. When gas is emitted from the valve 13, the gas passes through the opening 31.

In this embodiment, the openings 31 are disposed at the substrate 30 by the number of cells 10 constituting the cell stack 1. However, this should not be construed in a limiting sense. That is, the number of the openings 31 may be set appropriately. Specifically, it is only necessary to dispose at least one opening 31 with respect to the two valves 13 of the cells 10. Even in this case, gas emitted from the valve 13 passes through the opening 31.

Thus, it is only necessary that the opening 31 can cause gas emitted from the valve 13 to pass through. In this embodiment, the top surface of the cell stack 1 is covered with the substrate 30. Accordingly, forming the opening 31 at the substrate 30 can reduce gas emitted from the valve 13 to collide with the substrate 30.

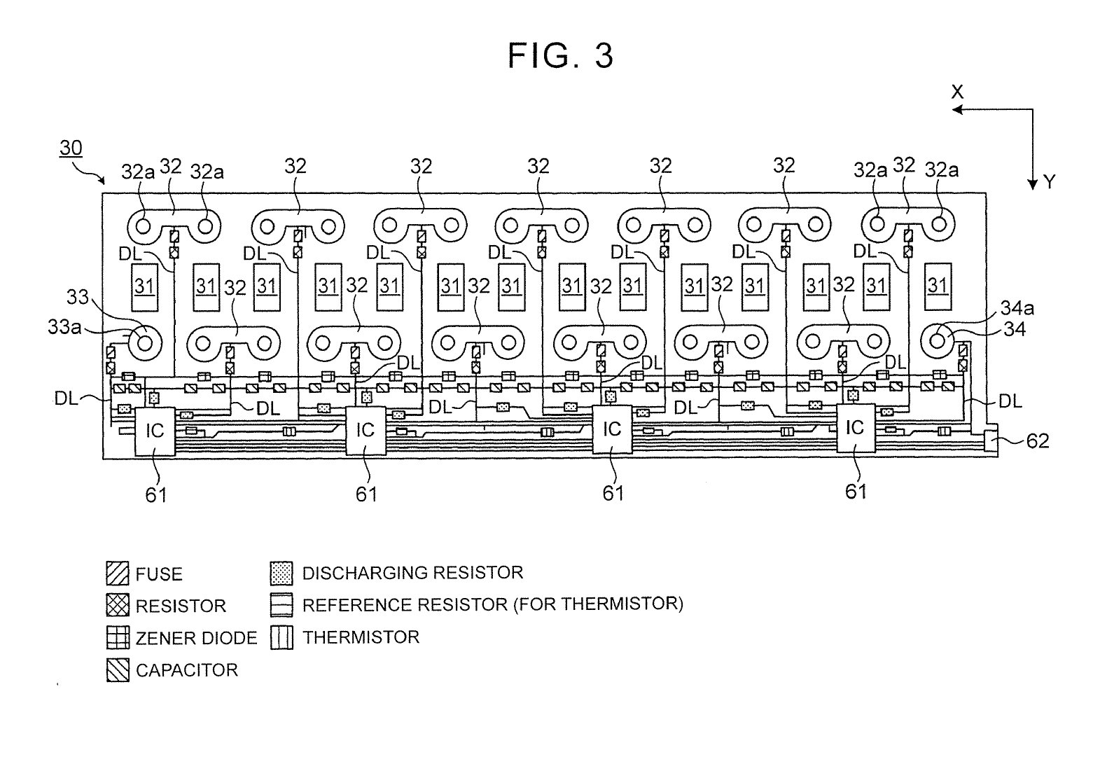

The substrate 30 includes a mounting region 32 to which a bus bar 40, which will be described later, to be mounted. The mounting regions 32 are disposed by the number of the bus bars 40, and are formed with a conductive material. As illustrated in FIG. 3, the mounting region 32 has two openings 32a. The electrode terminals 11 and 12 of the cell 10 penetrate the openings 32a. That is, in installing the substrate 30 to the top surface of the cell stack 1, the electrode terminals 11 and 12 penetrate the openings 32a, and the distal end portions of the electrode terminals 11 and 12 project upward with respect to the substrate 30.

As illustrated in FIG. 3, to each mounting region 32, a detecting line (wiring) DL is coupled. Here, one end of the detecting line DL is coupled to the mounting region 32, and the other end of the detecting line DL is coupled to a monitor IC (Integrated Circuit) 61. The monitor IC 61 is mounted to the substrate 30. In this embodiment, the four monitor ICs 61 are mounted to the substrate 30; however, the number of the monitor ICs 61 may be set appropriately. The substrate 30, the detecting line DL, and the monitor IC 61 constitute a substrate assembly 3.

As the substrate 30, a printed circuit board on which the detecting line DL or a similar pattern is printed may be employed. As the printed circuit board, for example, a flexible printed circuit board may be employed. In this embodiment, the mounting region 32 is formed at the substrate 30; however, the mounting region 32 may be omitted. That is, the bus bar 40 may directly contact the detecting line DL on the substrate 30. The detecting lines DL may directly contact the electrode terminals 11 and 12. That is, it is only necessary that the detecting lines DL may be electrically coupled to the electrode terminals 11 and 12.

Coupling regions 33 and 34 are disposed at both end portions of the substrate 30 in the X direction. The coupling regions 33 and 34 are formed with a conductive material. The coupling region 33 is electrically coupled to the positive electrode terminal 11 of the cell 10 disposed at one end of the cell stack 1 in the X direction. Here, the positive electrode terminal 11 electrically coupled to the coupling region 33 becomes the positive electrode terminal of the cell stack 1. In view of this, the positive electrode terminal 11 of the cell stack 1 is coupled to a load via a cable (not illustrated).

The coupling region 33 has an opening 33a. The positive electrode terminal 11 penetrates the opening 33a. That is, in installing the substrate 30 to the top surface of the cell stack 1, the positive electrode terminal 11 penetrates the opening 33a and the distal end portion of the positive electrode terminal 11 projects upward with respect to the substrate 30. The detecting line DL is also coupled to the coupling region 33. Here, one end of the detecting line DL is coupled to the coupling region 33, and the other end of the detecting line DL is coupled to the monitor IC 61.

The coupling region 34 is electrically coupled to the negative electrode terminal 12 of the cell 10 disposed at the other end of the cell stack 1 in the X direction. Here, the negative electrode terminal 12 coupled to the coupling region 34 becomes the negative electrode terminal of the cell stack 1. In view of this, the negative electrode terminal 12 of the cell stack 1 is coupled to the load via the cable (not illustrated). Thus, coupling the electrode terminals 11 and 12 of the cell stack 1 to the load via the cable allows the cell stack 1 to be charged and discharged.

The coupling region 34 has an opening 34a. The negative electrode terminal 12 penetrates the opening 34a. That is, in installing the substrate 30 to the top surface of the cell stack 1, the negative electrode terminal 12 penetrates the opening 34a and the distal end portion of the negative electrode terminal 12 projects upward with respect to the substrate 30. The detecting line DL is also coupled to the coupling region 34. Here, one end of the detecting line DL is coupled to the coupling region 34, and the other end of the detecting line DL is coupled to the monitor IC 61.

At an end portion of the substrate 30, a connector 62 is disposed. The connector 62 is coupled to the monitor ICs 61 via wiring. The connector 62 is used for transmitting information obtained at the monitor ICs 61 to the outside. Specifically, the connector 62 is coupled to a connector coupled to a battery ECU (an Electric Control Unit) (not illustrated). Thus, the information obtained at the monitor IC 61 can be transmitted to the battery ECU. The battery ECU can control charge and discharge of the cell stack 1 or the cell 10 using the information obtained from the monitor IC 61.

The bus bar 40 illustrated in FIG. 1 is constituted so as to electrically couple the two cells 10 adjacent in the X direction to each other. In this embodiment, all the cells 10 constituting the cell stack 1 are electrically coupled in series to each other. In view of this, the respective bus bars 40 are coupled to the positive electrode terminal 11 at one of the two cells 10 and the negative electrode terminal 12 at the other of the two cells 10. The bus bar 40 has two openings 41 through which the electrode terminals 11 and 12 penetrate. Nuts 42 are tightened to the distal end portions of the electrode terminals 11 and 12, which penetrate the openings 41.

Here, thread grooves are formed at the distal end portions of the electrode terminals 11 and 12. This thread groove meshes with a thread groove formed at the inner circumferential surface of the nut 42. Tightening the nuts 42 to the electrode terminals 11 and 12 can secure the bus bars 40 to the electrode terminals 11 and 12 and secure the substrate 30 to the electrode terminals 11 and 12. That is, tightening the nuts 42 to the electrode terminals 11 and 12 can secure the bus bars 40 and the substrate 30 in the longitudinal direction of the electrode terminals 11 and 12 (the vertical direction of the cell stack 1). As described above, the bus bar 40 contacts the mounting region 32 of the substrate 30. Accordingly, by coupling the bus bars 40 to the electrode terminals 11 and 12, it is possible to electrically couple the mounting regions 32 and the electrode terminals 11 and 12 to each other.

In tightening the nuts 42 to the electrode terminals 11 and 12, the bus bars 40 are disposed between the nuts 42 and the substrate 30 (the mounting regions 32). With the configuration where the nuts 42 are brought into direct contact with the substrate 30, the substrate 30 may be deformed while tightening the nut 42. In this embodiment, the bus bars 40 are disposed between the nuts 42 and the substrate 30. This can prevent force of tightening the nut 42 from acting on the substrate 30. This also can prevent deformation of the substrate 30.

To the electrode terminals 11 and 12 of the cell stack 1, coupling rings 43 and the nuts 42 are tightened instead of the bus bars 40. An end portion of a cable for coupling the cell stack 1 and the load to each other is coupled to the coupling ring 43. When the cell stack 1 is mounted to the vehicle, the above-described motor generator is equipped as a load. It is possible to secure the substrate 30 to the electrode terminals 11 and 12 of the cell stack 1 by using the nuts 42. Here, the coupling rings 43 are disposed between the electrode terminals 11 and 12 of the cell stack 1 and the nut 42. The coupling rings 43 contact the coupling regions 33 and 34 of the substrate 30. Thus, it is possible to electrically couple, via the coupling ring 43, the coupling region 33 and the positive electrode terminal 11 to each other, and/or the coupling region 34 and the negative electrode terminal 12 to each other.

In this embodiment, all the cells 10 constituting the cell stack 1 are electrically coupled in series to each other. However, this should not be construed in a limiting sense. Specifically, the cell stack 1 may include the plurality of cells 10 electrically coupled in parallel to each other. To electrically couple the plurality of cells 10 in parallel, it is only necessary to appropriately change an orientation of disposing the cells 10 (the electrode terminals 11 and 12) and the shape of the bus bar 40. That is, it is only necessary to electrically couple the plurality of cells 10 in parallel to each other.

At the top surface of the substrate 30, a duct 50 is disposed. The bottom surface of the duct 50 contacts the top surface of the substrate 30. The duct 50 is constituted such that gas emitted from the valve 13 of the cell 10 transfers to the direction away of the cell stack 1. For example, when the cell stack 1 is mounted to a vehicle, use of the duct 50 allows gas emitted from the valve 13 to emit to the outside of the vehicle. Here, another duct (not illustrated) may be coupled to the duct 50 illustrated in FIG. 1.

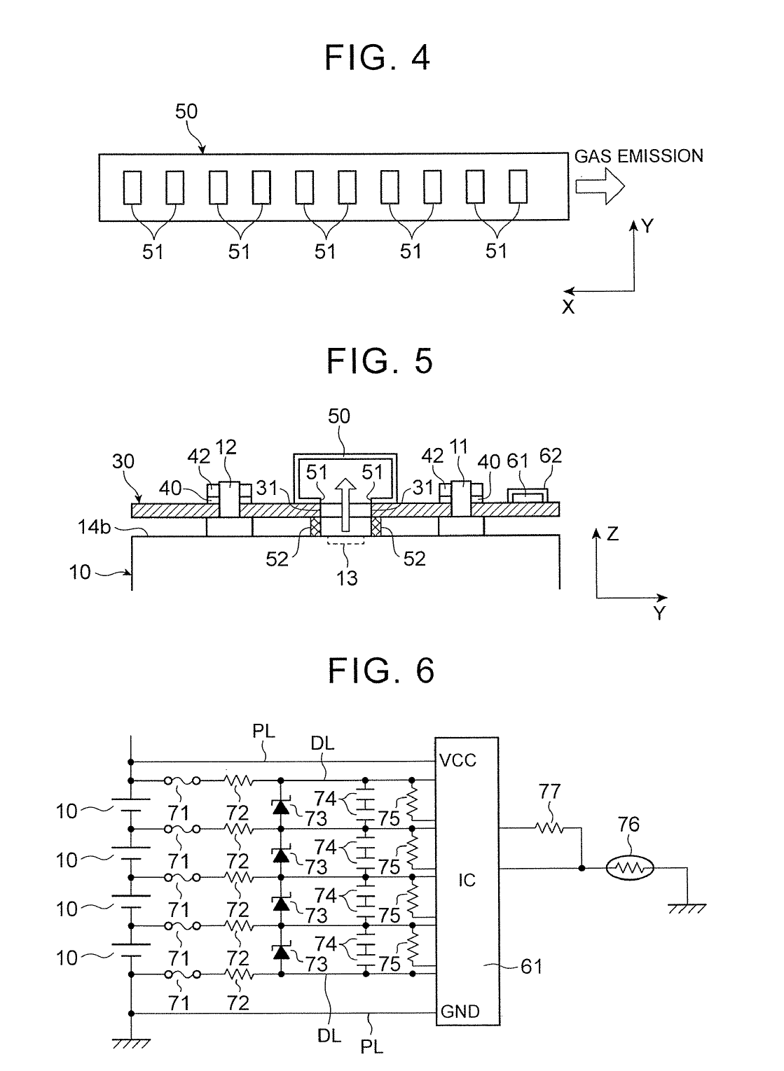

The duct 50 is disposed on the substrate 30 at a position avoiding the mounting region 32 and the coupling regions 33 and 34 and extends in the X direction. As illustrated in FIG. 4, the duct 50 has a plurality of openings 51. The openings 51 are disposed by the number of the openings 31. FIG. 4 is a schematic view of the duct 50 viewed from the substrate 30 side. The plurality of openings 51 are disposed along the longitudinal direction of the duct 50 (the X direction). Each opening 51 faces each opening 31 in the Z direction. The opening area of the opening 51 is equal to the opening area of the opening 31 or larger than the opening area of the opening 31.

As illustrated in FIG. 5, when gas is emitted from the valve 13 of the cell 10, the gas passes through the openings 31 and 51 and transfers to the inside of the duct 50. Here, the arrow illustrated in FIG. 5 indicates the direction of gas emission. Then, the gas transfers along the duct 50 and transfers to the direction away of the cell stack 1. Here, depending on the constitution of the cell 10, a space may be formed between the substrate 30 and the valve 13. In this case, as illustrated in FIG. 5, a sealing member 52 may be disposed between the substrate 30 and the valve 13 (the lid 14b).

The sealing member 52 may be disposed at a position surrounding the valve 13 and the opening 31 in a X-Y plane. Here, gas emitted from the valve 13 has a high temperature; therefore, it is preferred that a heat-resistant material be employed for the sealing member 52. It is possible to easily guide gas emitted from the valve 13 to the opening 31 by using the sealing member 52. This can prevent leakage of gas in a direction different from the direction toward the opening 31.

In this embodiment, the plurality of openings 51 are disposed at the duct 50. However, this should not be construed in a limiting sense. That is, the number of the openings 51 may be set appropriately. For example, it is only necessary to dispose at least one opening 51 with respect to the two openings 31. Even in this case, gas that passes through the opening 31 passes through the opening 51 and being guided to the inside of the duct 50. Thus, it is only necessary that the opening 51 can cause gas that passes through the opening 31 to guide to the inside of the duct 50.

In this embodiment, the opening 31 is formed at the substrate 30; however, the opening 31 may be omitted. In this case, it is only necessary to dispose the duct 50 between the substrate 30 and the cell 10 (the lid 14b). This allows gas emitted from the valve 13 to transfer to the duct 50. In a case where the substrate 30 is disposed above the duct 50, the opening 31 described in this embodiment is unnecessary. Omitting the opening 31 easily ensures the mounting area of the substrate 30, thus easily mounting the wiring and the monitor IC 61.

The cell stack 1 illustrated in FIG. 1 may be housed in a stack case (not illustrated). It is possible to protect the cell stack 1 by covering the cell stack 1 with the stack case. For example, when mounting the cell stack 1 to the vehicle, the cell stack 1 may be secured to the stack case, and the stack case may be secured to a vehicle body. The vehicle body includes, for example, a floor panel, a cross member, and a side member.

As illustrated in FIG. 3, not only the monitor IC 61 but also other electric elements are mounted to the substrate 30. The electric elements include a fuse, a resistor, a zener diode, a capacitor, a discharging resistor, a thermistor, and a reference resistor for thermistor. Here, in FIG. 6, a circuit configuration mounted to the substrate 30 is illustrated. In this embodiment, all electric elements including the monitor IC 61 are mounted to the top surface (one surface) of the substrate 30. Thus, mounting all the electric elements to the top surface of the substrate 30 facilitates mounting the electric elements.

In the configuration illustrated in FIG. 6, one monitor IC 61 monitors the four cells 10. The electrode terminals 11 and 12 of each cell 10 are coupled to the monitor IC 61 via the detecting lines DL. Each detecting line DL includes a fuse 71. The fuse 71 is constituted so as to suppress flow of excessive current from the cell 10 to the monitor IC 61. That is, when excessive current attempts to flow from the cell 10 to monitor IC 61, the fuse 71 is blown. This cuts off coupling between the cell 10 and the monitor IC 61.

The detecting line DL includes a resistor 72. The resistor 72 is electrically coupled to the fuse 71 in series. The resistor 72 configures an RC filter together with a capacitor 74 to cut off high frequency noise component of the cell 10. The resistor 72 may be omitted. A zener diode 73 is coupled to the two detecting lines DL coupled to the electrode terminals 11 and 12 of the cell 10. Specifically, the cathode of the zener diode 73 is coupled to the detecting line DL coupled to the positive electrode terminal 11 of the cell 10. The anode of the zener diode 73 is coupled to the detecting line DL coupled to the negative electrode terminal 12 of the cell 10. That is, the zener diode 73 is electrically coupled to the cell 10 in parallel via the two detecting lines DL.

The zener diode 73 is constituted so as to reduce application of overvoltage from the cell 10 to the monitor IC 61. That is, when an overvoltage attempts to be applied from the cell 10 to the monitor IC 61, a current flows from the cathode to the anode side of the zener diode 73 to reduce application of overvoltage to the monitor IC 61.

The two capacitors 74 are electrically coupled in parallel to each cell 10 via the detecting lines DL. The two capacitors 74 are electrically coupled in series to each other. One end at the one capacitor 74 is coupled to the detecting line DL coupled to the positive electrode terminal 11 of the cell 10. Meanwhile, one end at the other capacitor 74 is coupled to the detecting line DL coupled to the negative electrode terminal 12 of the cell 10. As illustrated in FIG. 6, the capacitors 74 are disposed at the monitor IC 61 side with respect to the zener diode 73.

In this embodiment, the two capacitors 74 are electrically coupled in parallel to each cell 10. However, this should not be construed in a limiting sense. Specifically, one capacitor 74 may be electrically coupled in parallel to each cell 10.

An electric charge of the cell 10 is charged to the capacitor 74. Accordingly, the voltage value of the two capacitors 74 is equal to the voltage value of the cell 10. The monitor IC 61 can obtain the voltage value of the cell 10 by detecting the voltage value of the two capacitors 74. One end of a discharging resistor 75 is coupled to the detecting line DL coupled to the positive electrode terminal 11 of the cell 10. The other end of the discharging resistor 75 is coupled to a transistor disposed inside the monitor IC 61.

The discharging resistor 75 is constituted such that voltage values or State of Charge (SOC) are equalized among the plurality of cells 10. Here, a process for equalizing the voltage value or SOC is referred to as an equalization process. The SOC indicates a ratio of the current charging capacity to a full charging capacity.

As described above, the monitor IC 61 can obtain a voltage value in each of the plurality of cells 10. Here, if the voltage values vary among the plurality of cells 10, the equalization process can be performed. If charge and discharge of the cell stack 1 is continued in a state where the voltage values are varied among the plurality of cells 10, only a voltage value of a specific cell 10 may reach the upper limit voltage or a lower limit voltage. In this case, charge or discharge of other cells 10 excluding the specific cell 10 is limited. Accordingly, the cells 10 cannot be efficiently charged and discharged.

Therefore, by reducing the variation of the voltage values by the equalization process, it is possible to charge and discharge all the cells 10 efficiently. In the equalization process, for example, the cell 10 with the highest voltage value is specified. Discharging the cell 10 allows a discharge current to flow to the discharging resistor 75. It is possible to lower the voltage value of the cell 10 by discharging the cell 10. Thus, by discharging the cell 10 indicating the highest voltage value, it is possible to reduce variation of the voltage values among the plurality of cells 10.

The monitor IC 61 includes a switch electrically coupled to the discharging resistor 75 in series. Turning on this switch allows the discharge current of the cell 10 to flow to the discharging resistor 75. Two power lines PL are coupled to the monitor IC 61. One power line PL is coupled to a VCC terminal of the monitor IC 61. The other power line PL is coupled to a GND terminal of the monitor IC 61.

Here, a thermistor 76 is coupled to the monitor IC 61. The thermistor 76 may be regarded as a temperature sensor of the present invention. The thermistor 76 is configured to detect the temperature of the cell 10. One end of the thermistor 76 is coupled to the monitor IC 61. The other end of the thermistor 76 is grounded. A reference voltage at the inside of the monitor IC 61 is generated from a power supply voltage input from the VCC terminal. The reference voltage is divided with a reference resistor 77 and the thermistor 76, and the divided voltage value is input to the monitor IC 61. When the resistance value of the thermistor 76 changes corresponding to the temperature of the cell 10, the voltage value input to the monitor IC 61 also changes. In view of this, the monitor IC 61 can obtain the temperature of the cell 10 by monitoring the input voltage value.

In this embodiment, the thermistor 76 is mounted to the top surface of the substrate 30. In other words, the thermistor 76 is disposed at a surface (the top surface) opposite from the surface (the bottom surface) of the substrate 30 facing the cell 10. Since the thermistor 76 is employed for detecting the temperature of the cell 10, the thermistor 76 is preferred to be disposed at the proximity of the cell 10. Here, when the thermistor 76 is disposed at the bottom surface of the substrate 30 facing the cell 10, the temperature of the cell 10 is easily detected with the thermistor 76.

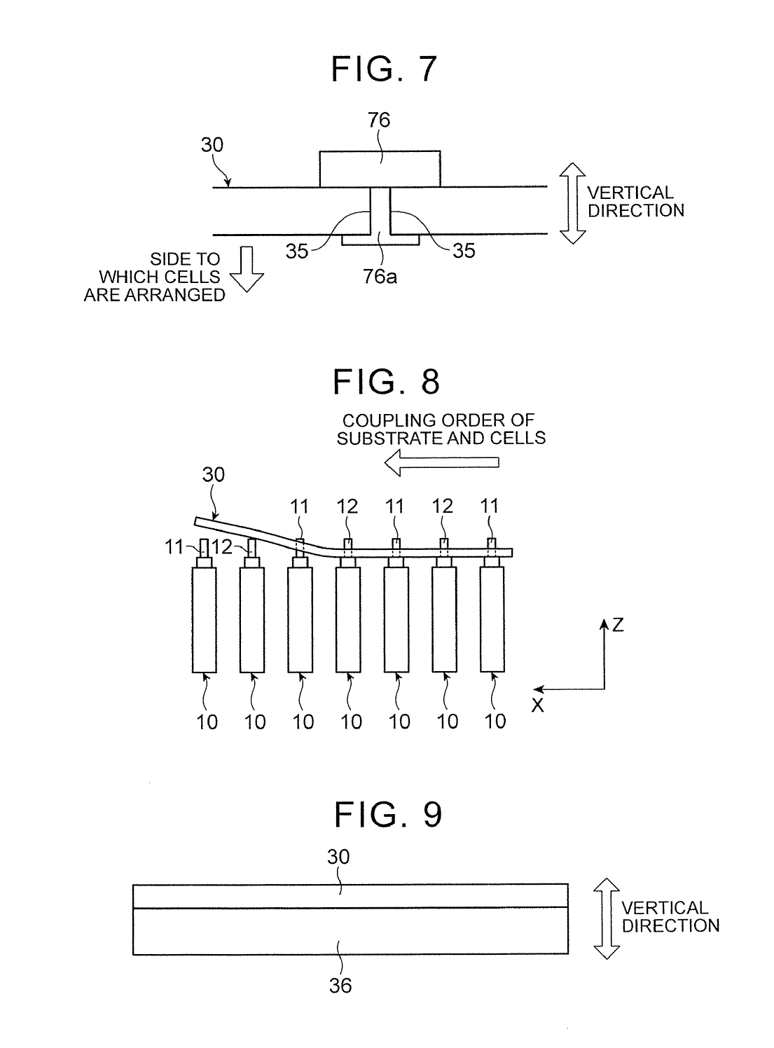

On the other hand, when the thermistor 76 is mounted to the top surface of the substrate 30, as illustrated in FIG. 7, a through-hole 35 may be formed at the substrate 30 and a wiring 76a of the thermistor 76 may be extended to the bottom surface of the substrate 30. The wiring 76a positioned at the bottom surface of the substrate 30 is adjacent to the cell 10; therefore, the resistance value of the thermistor 76 is easily changed corresponding to the temperature of the cell 10. Here, when the wiring 76a positioned at the bottom surface of the substrate 30 is brought into contact with the cell 10, the resistance value of the thermistor 76 is more easily changed corresponding to the temperature of the cell 10.

When the substrate 30 is mounted to the top surface of the cell stack 1, the substrate 30 and the cells 10 can be coupled to each other from one end to the other end of the cell stack 1 in the X direction. That is, as illustrated in FIG. 8, the substrate 30 and the cells 10 can be coupled to each other in an order from the end of the cell stack 1 in the X direction. In other words, in the order from the end of the cell stack 1 in the X direction, the nuts 42 and the bus bars 40 are tightened to the electrode terminals 11 and 12 of the cells 10.

Here, it is possible to easily couple the substrate 30 and the cell 10 to each other by using the flexible substrate as the substrate 30. That is, the substrate 30 and the cells 10 can be coupled in this order while the substrate 30 is deformed.

The substrate 30 and the cells 10 are coupled in the order from the end of the cell stack 1. This reduces generation of overcurrent due to a parasitic diode of the monitor IC 61. With the constitution using the substrate 30, the nuts 42 can be freely tightened to the electrode terminals 11 and 12. In view of this, the substrate 30 and the cells 10 can be irregularly coupled to each other.

However, irregular coupling of the substrate 30 and the cells 10 (in other words, tightening of the nuts 42) possibly causes flow of overcurrent due to the parasitic diode of the monitor IC 61 coupled to the cells 10 via the detecting lines DL. For example, when the electrode terminals 11 and 12 are irregularly coupled to the bus bar 40, terminals of the plurality of cells 10 may be coupled to the monitor IC 61 after the plurality of cells 10 are electrically coupled in series to each other.

In this case, due to the parasitic diode of the monitor IC 61, overcurrent flows from the plurality of cells 10. According to this embodiment, the bus bar 40 and the electrode terminals 11 and 12 are coupled to each other in an order from the cell 10 positioned at the end of the cell stack 1. As described above, this can prevent the terminals of the plurality of cells 10 from being coupled to the monitor IC 61 after the plurality of cells 10 electrically are coupled in series to each other. Accordingly, overcurrent due to the parasitic diode of the monitor IC 61 can be prevented.

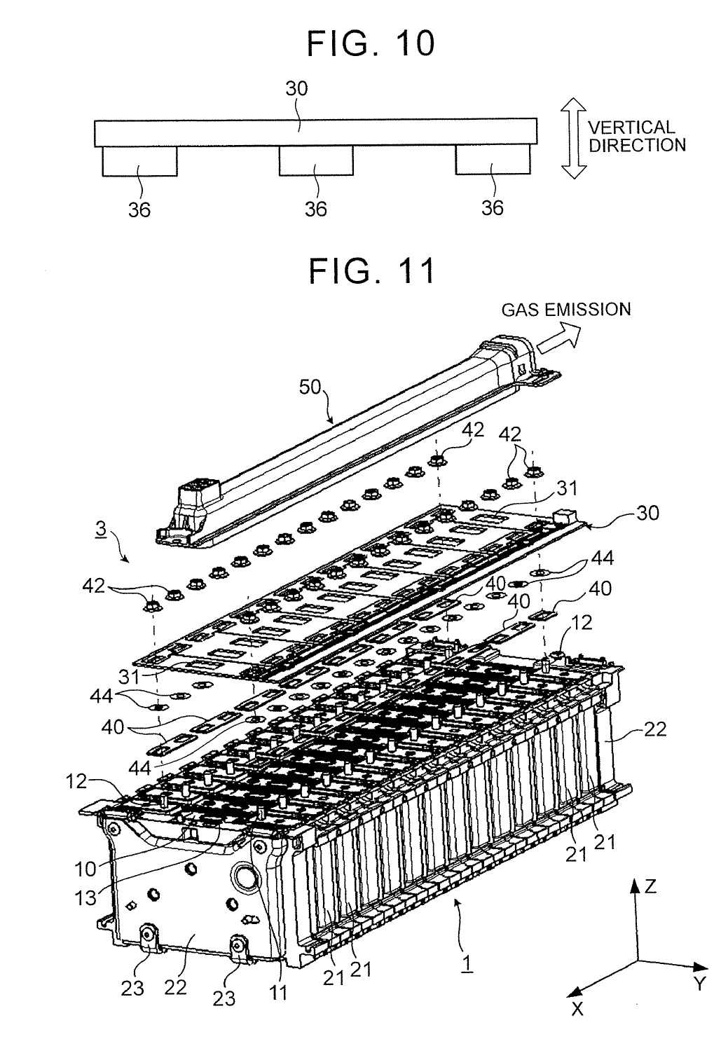

In this embodiment, to reduce deflection of the substrate 30, as illustrated in FIG. 9 or FIG. 10, a reinforcing member 36 may be disposed at the substrate 30. In particular, in the case where a flexible substrate is employed as the substrate 30, since the substrate 30 is likely to deflect, disposing the reinforcing member 36 is preferred. Deformation of the substrate 30 may cause poor coupling or a similar failure in a circuit configuration mounted to the substrate 30. Therefore, when deformation of the substrate 30 is reduced using the reinforcing member 36, poor coupling or a similar failure can be prevented. The reinforcing member 36 may be formed with a heat-resistant material similarly to the substrate 30.

With the configuration illustrated in FIG. 9, the reinforcing member 36 is disposed over the entire surface of the substrate 30. With the configuration illustrated in FIG. 10, the plurality of reinforcing members 36 are disposed at the substrate 30. With the configuration illustrated in FIG. 9 and FIG. 10, the reinforcing member 36 is disposed at the bottom surface of the substrate 30. However, the reinforcing member 36 may be disposed at the top surface of the substrate 30.

With the configuration illustrated in FIG. 9 or FIG. 10, openings are formed at the parts where the electrode terminals 11 and 12 penetrate at the reinforcing member 36. Here, the reinforcing member 36 may be preliminary secured to the substrate 30 with an adhesive or a similar agent. The reinforcing member 36 may only be stacked without securing the reinforcing member 36 and the substrate 30. With the configuration illustrated in FIG. 10, the position of disposing the reinforcing member 36 and the number of reinforcing members 36 may be set appropriately. That is, it is only necessary to appropriately dispose the reinforcing member 36 so as to reduce deflection of the substrate 30.

In the cell stack 1 of this embodiment, as illustrated in FIG. 1, the substrate 30 is disposed between the cells 10 and the bus bars 40. However, this should not be construed in a limiting sense. As described in this embodiment, it is only necessary that the bus bar 40 can electrically couple the two cells 10 adjacent in the X direction to each other. In view of this, for example, similarly to the cell stack 1 illustrated in FIG. 11, the bus bars 40 may be disposed between the substrate 30 and the cells 10.

FIG. 11 is an exploded view of the cell stack 1 of a modification of the embodiment. In FIG. 11, members having the same functions as members described in this embodiment (in particular, FIG. 1) are assigned the same reference numerals, and will not be further elaborated here. In FIG. 11, the restraint band 23 disposed at the top surface of the cell stack 1 is omitted.

With the configuration illustrated in FIG. 11, the electrode terminals 11 and 12 of the cell 10 penetrate the bus bars 40 and the substrate 30, similarly to the embodiment described above. The nuts 42 are tightened to the electrode terminals 11 and 12 projecting from the substrate 30. In this modification, spring washers 44 are disposed between the bus bars 40 and the substrate 30. The electrode terminals 11 and 12 penetrate the spring washers 44. The spring washer 44 generates biasing force in the direction separating the bus bars 40 and the substrate 30 sandwiching the spring washers 44 from one another (the vertical direction of the cell stack 1). It is possible to suppress looseness of the nut 42 or a similar failure by using the spring washer 44.

The position of disposing the spring washer 44 may be set appropriately. As illustrated in FIG. 11, in the case where the nuts 42, the substrate 30, the bus bars 40, and the cells 10 are disposed in this order from upward to downward of the cell stack 1, the spring washers 44 may be disposed among the two members adjacent to one another in the vertical direction of the cell stack 1. Specifically, the spring washers 44 may be disposed between the nuts 42 and the substrate 30, between the substrate 30 and the bus bars 40, or between the bus bars 40 and the cells 10.

Among the nuts 42, the substrate 30, the bus bars 40, and the cells 10, when the spring washers 44 are disposed between the two members adjacent to one another, a plurality of spring washers 44 may be employed. Specifically, the spring washers 44 may be disposed at least two of: between the nuts 42 and the substrate 30, between the substrate 30 and the bus bars 40, and between the bus bars 40 and the cells 10.

Meanwhile, even with the configuration illustrated in FIG. 1, the spring washer 44 described in the modification may be employed. With the configuration illustrated in FIG. 1, even when the spring washer 44 is used, the position of disposing the spring washer 44 may be set appropriately. With the configuration illustrated in FIG. 1, the spring washers 44 may be disposed at least one of: between the nuts 42 and the bus bars 40 (including the coupling rings 43), between the bus bars 40 and the substrate 30, and between the substrate 30 and the cells 10.

With this modification, the bottom surface of the substrate 30, in other words, the surface of the substrate 30 facing the bus bars 40 includes regions of contacting the bus bars 40. In this modification, the regions of contacting the bus bars 40 may be regarded as the mounting regions 32 described in this embodiment. A plurality of electric elements are mounted to the top surface of the substrate 30 similarly to the configuration illustrated in FIG. 3. The electric elements include, as described using FIG. 3, the detecting line DL, the fuse, the resistor, the zener diode, the capacitor, the discharging resistor, the thermistor, the reference resistor for thermistor, and the monitor IC 61.

Through-holes are formed at a region of the substrate 30 contacting the bus bars 40. The bus bars 40 contacting the bottom surface of the substrate 30 are electrically coupled to the detecting line DL mounted to the top surface of the substrate 30 via the through-holes formed at the substrate 30. This allows the electric element mounted to the top surface of the substrate 30 to be electrically coupled to the cells 10.

What is claimed is:

1. An electric storage device comprising:
a plurality of electric storage elements arranged in a predetermined direction;
a substrate through which an electrode terminal of each of the electric storage elements penetrates; and
a bus bar coupled to the electrode terminal penetrating through the substrate, the bus bar electrically coupling the plurality of electric storage elements to each other, wherein
a voltage detecting line and an electronic circuit are mounted to the substrate, the voltage detecting line being electrically coupled to the electrode terminal, the voltage detecting line being configured to detect a voltage of each of the electric storage elements, the electronic circuit being coupled to the voltage detecting line.

2. The electric storage device according to claim 1, wherein
the electric storage element includes a valve configured to emit gas generated inside the electric storage element to an outside of the electric storage element, and
the substrate includes an opening configured to cause gas emitted from the valve to pass through the opening and guide to a duct.

3. The electric storage device according to claim 2, further comprising
a sealing member disposed between the substrate and the valve and at a position surrounding the valve and the opening.

4. The electric storage device according to claim 1, further comprising
a nut tightened to the electrode terminal penetrating through the substrate, the nut securing the bus bar and the substrate in a longitudinal direction of the electrode terminal.

5. The electric storage device according to claim 4, wherein
the bus bar is disposed between the nut and the substrate.

6. The electric storage device according to claim 4, further comprising
a spring washer through which the electrode terminal penetrates, wherein
the spring washer biases members that sandwich the spring washer to a direction of separating from one another in the longitudinal direction of the electrode terminal.

7. The electric storage device according to claim 1, further comprising
a temperature sensor configured to detect a temperature of the electric storage element, wherein
the temperature sensor is mounted to the substrate and coupled to the electronic circuit.

8. The electric storage device according to claim 1, further comprising
a reinforcing member stacked on the substrate.

9. The electric storage device according to claim 1, wherein
the substrate is formed with a heat-resistant material.

10. The electric storage device according to claim 1, wherein
the substrate is a flexible substrate.

11. A substrate assembly mounted to a plurality of electric storage elements arranged in a predetermined direction, the substrate assembly comprising:
a substrate that includes a mounting region and an opening through which an electrode terminal of each of the electric storage elements penetrates, the mounting region being coupled to the electrode terminal penetrating through the opening, a bus bar being mounted to the mounting region, the bus bar electrically coupling the plurality of electric storage elements to each other;
a voltage detecting line mounted to the substrate, the voltage detecting line being electrically coupled to the electrode terminal so as to detect a voltage of each of the electric storage elements; and
an electronic circuit mounted to the substrate, the voltage detecting line being coupled to the electronic circuit.

12. An assembly method for an electric storage device with a plurality of electric storage elements electrically coupled in series to a bus bar, the assembly method comprising:
arranging the plurality of electric storage elements in a predetermined direction; and
coupling an electrode terminal of each of the electric storage elements to a voltage detecting line in an order from one of the electric storage elements positioned at an end of the electric storage device in the predetermined direction, the coupling being performed while causing the electrode terminal of each of the electric storage elements to penetrate through a substrate where the voltage detecting line and an electronic circuit are mounted, the voltage detecting line being configured to detect a voltage of each of the electric storage elements, the electronic circuit being coupled to the voltage detecting line.
